(19) United States
(12) Patent Application Publication
(10) Pub. No.: US 2012/0151231 A1
(43) Pub. Date: Jun. 14, 2012

(54) POWER SUPPLY SWITCHING DEVICE, A POWER SUPPLY SWITCHING DEVICE CONTROL METHOD AND A POWER SUPPLY CONTROL PROGRAM

(76) Inventor: ATSUSHI HATTA, Tokyo (JP)

(21) Appl. No.: 13/312,397

(22) Filed: Dec. 6, 2011

(30) Foreign Application Priority Data
Dec. 9, 2010 (JP) 274813/2010

(51) Int. Cl. G06F 1/32

(52) U.S. Cl. 713/320

(57) ABSTRACT

A power supply switching device is comprising: a first connector which connects with a USB (Universal Serial Bus) power bus which supplies electric power; a second connector which connects with a USB connector; and a switching unit which switches between a supplying state in which electric power is supplied from the USB power bus to the USB connector and a cutoff state in which electric power is not supplied from the USB power bus to the USB connector.

This application is based upon and claims the benefit of priority from Japanese Patent Application No. 2010-274813, filed on Dec. 9, 2010, the disclosure of which is incorporated herein in its entirety by reference.

### TECHNICAL FIELD

The present invention relates to a power supply switching device which switches a state of electric power supply between a supplying state and a cutoff state, and in particular, relates to a power supply switching device which switches a state of electric power supply for a power source pin of a USB (Universal Serial Bus) connector between a supplying state and a cutoff state.

### BACKGROUND ART

First, a configuration of an ordinary computer system will be described with reference to the drawings.

FIG. 7 is a block diagram illustrating the structure of an ordinary computer system.

Referring to FIG. 7, the computer system of FIG. 7 includes a computer device 90 and a USB device 3.

The computer device 90 includes a control unit 11 and a USB connector 12. The computer device 90 may further include an input unit 2:

The USB device 3 and the USB connector 12 may be connected via a USB cable, or may be connected via a connector which is provided in the USB device 3, fits the USB connector 12, and is not illustrated. Also, the computer device 90 supplies electric power to the USB device 3 via the USB connector 12. Generally, among USB devices, there are devices which operate only by electric power supplied via the USB connector 12 and devices which operate using electric power supplied from other power source devices and so on.

The control unit 11 and the USB connector 12 are connected via a USB data bus 101 and a USB power bus 100. Further, the USB data bus is a part of the USB, which sends and receives data. And, the USB power bus is a part of the USB, which supplies electric power. Via the USB power bus 100, the control unit 11 supplies electric power to the USB device 3 connected with the USB connector 12. And, via the USB data bus 101, the control unit 11 transmits instructions to the USB device 3 connected with the USB connector 12, sends data to the USB device 3 and receives data from the USB device 3.

In patent document 1, a USB apparatus which includes a common startup control unit and a plurality of USB devices is disclosed. The USB apparatus is connected with a host computer by a USB cable. Each USB device is a hard disk, a flash memory or the like which operates when connected with the host computer individually. Electric power is supplied to the common startup control unit and each USB device via the USB cable.

Each USB device includes a USB controller and a CPU (Central Processing Unit).

Each USB device includes, between an input unit of electric power and the USB controller, a first power switch which supplies the electric power to the USB controller and a second power switch. The common startup control unit performs ON/OFF control of the first power switch of each USB device. Also, each USB device includes, between the USB controller and the CPU, the second power switch which supplies the electric power to the CPU and a third power switch. The USB controller of each USB device performs ON/OFF control of the second power switch.

The common startup control unit includes a control unit power switch, a startup control table and a power control unit. The control unit power switch supplies the electric power supplied via the USB cable to the startup control table and the power control unit. The CPU of each USB device performs ON/OFF control of the control unit power switch. Order of priority of startup and a startup state (ON or OFF) of each USB device, and information on the USB device which becomes a master are stored in the startup control table.

In an initial state, the first switch of one predetermined USB device is in the ON state. After each USB device is started up according to the startup control table, a plurality of USB devices are connected with the host computer and operate.

In case a direction to switch all USB devices to a power saving state is sent from the host computer, all the power switches other than the first power switch which supplies the electric power to the USB controller of the master USB device switch to the OFF state. In case a direction to recover from the power saving state is sent from the host computer, the same process as the above-mentioned process of starting up is performed.

### PRECEDING TECHNICAL LITERATURE

### Patent Document

[Patent document 1] Japanese Patent Application Laid-Open No. 2007-310647

### SUMMARY

The object of the present invention is to provide a power supply switching device which switches between a state in which electric power is supplied from a computer device to a USB device connected with the computer device and a state in which the electric power for the USB device is cut off, while keeping a state that the USB device is connected with the computer device.

In case the USB device 3 is connected with the computer device 90 shown in FIG. 7, while the power source of the computer device 90 is on, the control unit 11 constantly supplies electric power to the USB device 3 via the USB power bus 100 and the USB connector 12.

However, the computer device 90 shown in FIG. 7 cannot switch between a state in which electric power is supplied to the USB device 3 connected with the USB connector 12 and a state in which electric power for the USB device 3 is cut off, while keeping the state that the USB device 3 is connected with the USB connector 12.

The host computer described in patent document 1 constantly supplies electric power to at least one USB device which the USB apparatus connected with the host computer by the USB cable includes.

Technology described in patent document 1 cannot switch between a state in which electric power is supplied to the USB apparatus connected with the host computer via the USB cable and a state in which electric power for the USB apparatus is cut off, while keeping the state that the USB apparatus is connected with the host computer.

### Measures for Solving the Problems

A power supply switching device is comprising: a first connector which connects with a USB (Universal Serial Bus) power bus which supplies electric power; a second connector which connects with a USB connector; and a switching unit which switches between a supplying state in which electric power is supplied from the USB power bus to the USB connector and a cutoff state in which electric power is not supplied from the USB power bus to the USB connector.

### Effect of the Invention

The present invention has the effect that the computer device can cut off selectively, among accesses to the USB device connected with the computer device, access to the USB device which operates only by electric power supplied by the USB.

### BRIEF DESCRIPTION OF THE DRAWINGS

Exemplary features and advantages of the present invention will become apparent from the following detailed description when taken with the accompanying drawings in which:

FIG. 1 is a block diagram illustrating the structure of the first exemplary embodiment;

FIG. 2 is a block diagram illustrating an example of a power supply switching device 10 of the first exemplary embodiment;

FIG. 3 is a flow chart illustrating the operation when switching to a supplying state in the first exemplary embodiment;

FIG. 4 is a flow chart illustrating the operation when switching to a cutoff state in the first exemplary embodiment;

FIG. 5 is a block diagram illustrating the structure of the second exemplary embodiment;

FIG. 6 is a flow chart illustrating the operation of the second exemplary embodiment;

FIG. 7 is a block diagram illustrating the structure of an ordinary computer; and

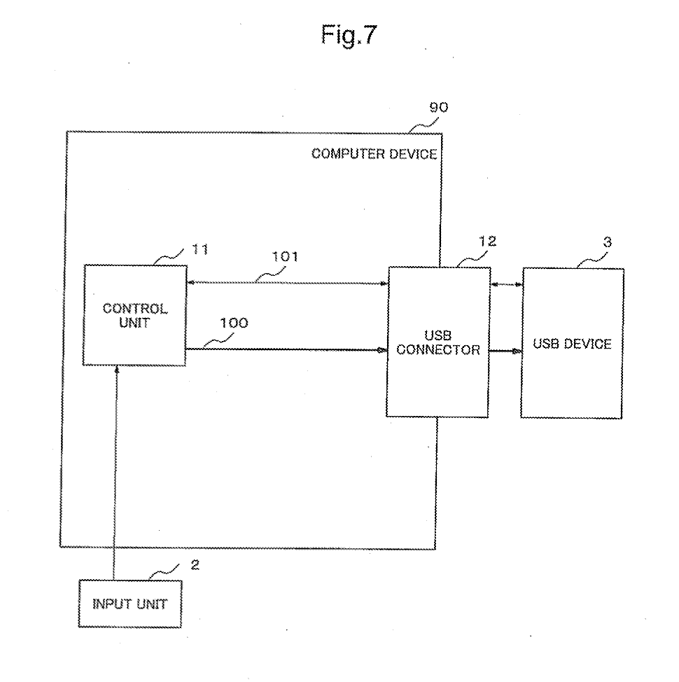

FIG. 8 is a block diagram illustrating the structure of a power supply switching device 10.

### EXEMPLARY EMBODIMENT

Next, a detailed explanation will be given for a first exemplary embodiment with reference to the drawings.

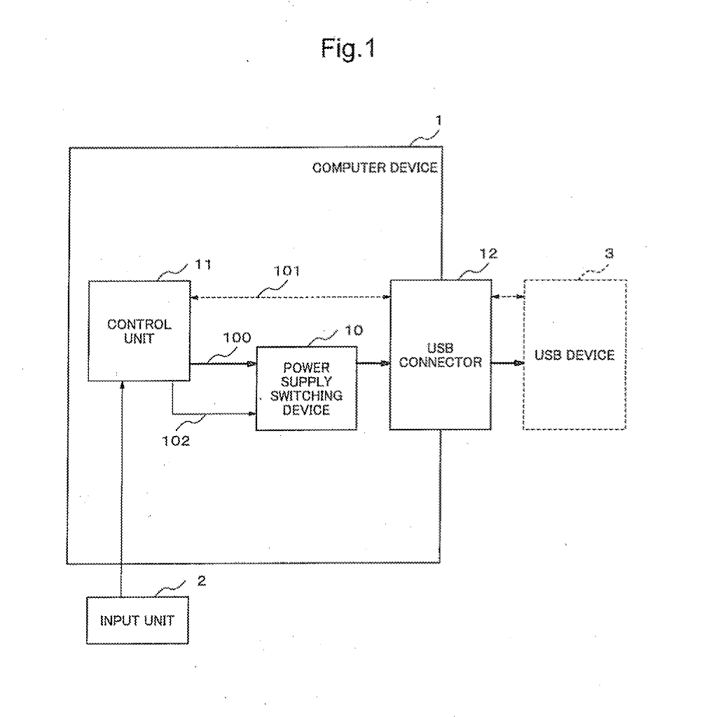

FIG. 1 is an exemplary block diagram showing the configuration of a computer system of the first exemplary embodiment. The computer system shown in FIG. 1 includes a computer device 1, an input unit 2 and a USB device 3.

The computer device 1 includes a power supply switching device 10, a control unit 11 and a USB connector 12.

The power supply switching device 10 is connected with the USB connector 12 and a USB power bus 100 which is used for supplying electric power to a device connected with the USB connector 12. The power supply switching device 10 switches between a supplying state in which electric power is supplied from the USB power bus 100 to the USB connector 12 and a cutoff state in which electric power from the USB power bus 100 to the USB connector 12 is cut off.

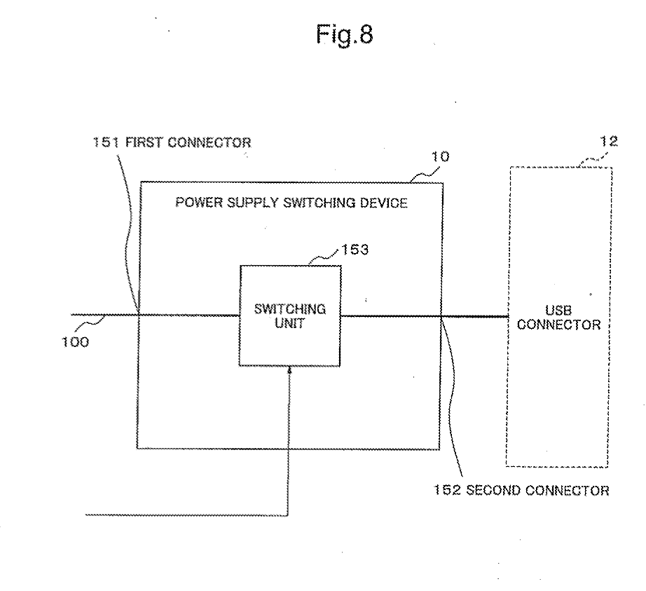

FIG. 8 is a block diagram illustrating the structure of the power supply switching device 10.

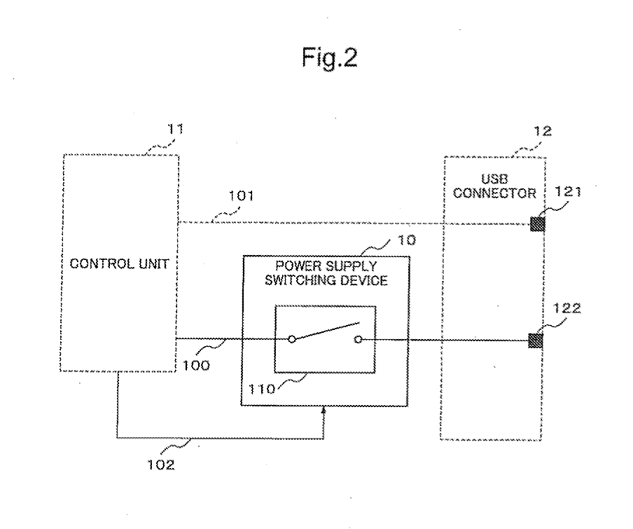

The power supply switching device 10 includes a first connector 151 which connects with the USB power bus 100, a second connector 152 which connects with the USB connector 12, and a switching unit 153. The switching unit 153 receives a direction, and, in accordance with the received direction, switches between the supplying state in which the first connector 151 and the second connector 152 are connected and the cutoff state in which the first connector 151 and the second connector 152 are not connected. The switching unit 153 may include a power switch 110 shown in FIG. 2 mentioned below, which is, for example, connected with the USB power bus 100 via the first connector 151, and connected with the USB connector 12 via the second connector 152. In the following description, operation of switching between the supplying state and the cutoff state, which the switching unit 153 performs, will be described as the operation which the power supply switching device 10 performs. Further, in FIG. 2 mentioned below, the first connector 151 and the second connector 152 are omitted.

And, the power supply switching device 10 is connected with the control unit 11 by, for example, GPIO 102 (General Purpose Input/Output). The power supply switching device 10 receives the direction to switch to the cutoff state (cutoff state switching direction) and the direction to switch to the supplying state (supplying state switching direction) from the control unit 11 via, for example, the GPIO 102. The GPIO 102 is a general-purpose input/output interface which can be accessed from CPU and so on. The power supply switching device 10 may be connected with the control unit 11, not via the GPIO 102, but via a dedicated communication path for transmitting the direction to switch to the cutoff state and the direction to switch to the supplying state. When the power supply switching device 10 receives the direction to switch to the cutoff state from the control unit 11, the power supply switching device 10 switches to the cutoff state. And, when the power supply switching device 10 receives the direction to switch to the supplying state from the control unit 11, the power supply switching device 10 switches to the supplying state. Further, the power supply switching device 10 can be made including a structure such that in an initial state, which includes a state immediately after a power source of the computer device 1 is turned on or immediately after the computer device 1 is restarted, the power supply switching device 10 is in the cutoff state. In this case, if the control unit 11 transmits neither direction to the power supply switching device 10, the power supply switching device 10 stays in the cutoff state.

FIG. 2 is a block diagram illustrating an example of the power supply switching device 10.

Referring to FIG. 2, the power supply switching device 10 includes the power switch 110 connected with the USB power bus 100 and a power source pin 122 of the USB connector 12. When the power supply switching device 10 is in the supplying state, the power switch 110 is connected. And, when the power supply switching device 10 is in the cutoff state, the power switch 110 is made open.

In the structures described in FIG. 1 and FIG. 2, the USB power bus 100 is connected with the control unit 11, and the control unit 11 supplies electric power via the USB power bus 100. However, the USB power bus 100 may be connected with a component which can supply electric power such as a power source device which is not shown instead of the control unit 11.

The control unit 11 may, in the initial state, transmit the direction to switch to the cutoff state to the power supply switching device 10, for example, via the GPIO 102 as mentioned above, and let the power supply switching device 10 be in the cutoff state. As mentioned above, the initial state includes a state immediately after the power source of the computer device 1 is turned on, and a state immediately after the computer device 1 is restarted. When the input unit 2 mentioned below inputs a supplying direction (a direction to switch the power supply device 10 to the supplying state) which is a direction to supply electric power to the USB device 3, the control unit 11 may transmit the direction to switch to the supplying state, for example, via the GPIO 102, to the power supply switching device 10.

Further, the GPIO 102 can be made in a structure in which the GPIO 102 can take, for example, a state of Enable and a state of Disable. And the power supply switching device 10 can be made in a structure such that: in case the GPIO 102 is in the state Enable, the power supply switching device 10 becomes the supplying state, and in case the GPIO 102 is in the state of Disable, the power supply switching device 10 becomes the cutoff state. In this case, the control unit 11 sends the direction to switch to the supplying state to the power supply switching device 10 by setting the GPIO 102 to be in the state of Enable. Also, the control unit 11 sends the direction to switch to the cutoff state to the power supply switching device 10 by setting the GPIO 102 to be in the state of Disable. The control unit 11 can make the power supply device 10 in the cutoff state in the initial state, by structuring the GPIO 102 such that the GPIO 102 is in the state of Disable in the initial state.

And, the control unit 11 may be structured such that the control unit 11 is connected with the USB data bus 101, which is connected with the USB connector 12 and which is for sending data to the USB device 3 and receiving data from the USB device 3, and sends data to the USB device 3 and receives data from the USB device 3. In this case, as shown in FIG. 2, the USB data bus 101 may be connected with the control unit 11 and a data pin 121 of the USB connector 12. Further, the number of the USB data buses 101 and the number of the data pins 121 are at least the number necessary for sending data and receiving data.

The input unit 2 is an input unit such as a keyboard and so on. The input unit 2 may be included in the computer device 1.

The USB device 3 is a memory device, such as a flash memory and so on, which can be connected with the computer device 1 by USB. The USB device 3 operates by electric power supplied via the USB connector 12. The USB device 3 is, for example, a memory device such as a USB memory, which is contained in a housing of the computer device 1 and is connected with a USB connector 12 which is an internal connector of the computer device 1 and which is contained in the housing of the computer device 1. Also, the USB device 3 may be connected, for example, with a USB connector 12 equipped toward outside of the housing of the computer device 1.

Next, a detailed explanation will be given for an operation of this exemplary embodiment with reference to the drawings.

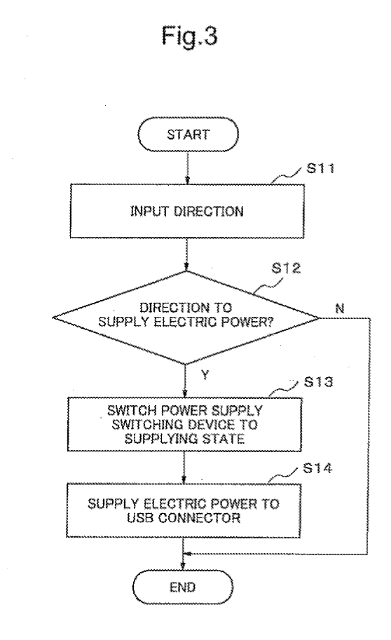

FIG. 3 is a flow chart illustrating the operation of this exemplary embodiment when switching from the cutoff state to the supplying state.

As mentioned above, in the initial state, the control unit 11 makes the power supply switching device 10 in the cutoff state.

Referring to FIG. 3, first, the control unit 11 receives a cutoff direction (a direction to cut off electric power for the USB connector 12, which makes the power supply switching device 10 to switch to the cutoff state) or the supplying direction from the input unit 2 (Step S11). The cutoff direction or the supplying direction is a direction which a user or an operator inputted via the input unit 2. The control unit 11 may display an expression which prompts an input of the cutoff direction or the supplying direction on a display device on which the computer device 1 displays output. The user or the operator may input the cutoff direction or the supplying direction using the input unit 2 such as a keyboard. The user or the operator can give the cutoff direction or the supplying direction by pressing either of specific keys each of which is assigned in advance to the cutoff direction or the supplying direction. Also, in case no direction is given, the control unit 11 may assume that the cutoff direction is given. For example, the user or the operator may give the cutoff direction by not inputting anything for a predetermined time. In this case, in Step S11, when neither direction is inputted in the predetermined time after, for example, displaying an expression which prompts an input of directions, the control unit 11 may assume that it has received the cutoff direction. Also, in case an input other than an input the cutoff direction or an input the supplying direction is given, the control unit 11 may assume that it has received the cutoff direction.

In case the direction which the control unit 11 received is not the supplying direction (Step S12, N), the control unit 11 ends the processing.

In case the direction which the control unit 11 received is the supplying direction (Step S12, Y), the control unit 11 transmits the direction to switch to the supplying state to the power supply switching device 10 via, for example, the GPIO 102 and switches the power supply switching device 10 to the supplying state (Step S13).

When the direction to switch to the supplying state is received, the power supply switching device 10 supplies electric power to the USB connector 12 by, for example, connecting the power switch 110 (Step S14). When electric power is supplied to the USB connector 12, the USB device 3 connected with the USB connector 12 is supplied electric power via the USB connector 12, and begins operation.

Also, when the USB device 3 becomes unnecessary, the user or the operator may switch the power supply switching device 10 to the cutoff state by giving the direction via the input unit 2.

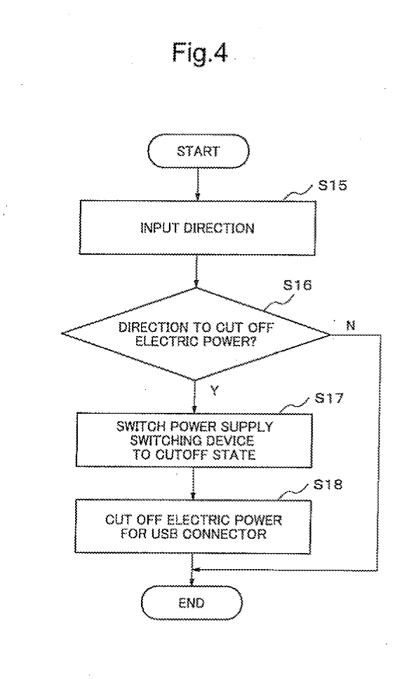

FIG. 4 is a flow chart illustrating the operation of this exemplary embodiment in case switching from the supplying state to the cutoff state. In this case, at the time the processing begins, the power supply switching device 10 is in the supplying state.

Referring to FIG. 4, first, an operator inputs the cutoff direction to the input unit 2 (Step S15).

In case the direction which the control unit 11 received from the input unit 2 is the cutoff direction (Step S16, Y), the control unit 11 transmits the direction to the power supply switching device 10 to switch to the cutoff state (Step S17). In case the direction which the control unit 11 received from the input unit 2 is not the cutoff direction (Step S16, N), the operation ends.

When the direction to switch to the cutoff state is received, the power supply switching device 10 stops electric power to the USB connector 12 by, for example, making the power switch 110 open (Step S18). When electric power via the USB connector 12 stops, the USB device 3 ends operation. Further, in case an operation to end communication between the computer device 1 and the USB device 3 is necessary before stopping electric power to the USB device 3, the operator may do the operation to end the communication between the computer device 1 and the USB device 3 before inputting the cutoff direction.

In the exemplary embodiment described above, there is a first effect that, among accesses from the computer device 1 to the USB device connected with the computer device 1, accesses to the USB device which operates only by electric power supplied via a USB connector from the computer device 1 can be cut off selectively

The reason is because the power supply switching device 10 switches the state in which electric power is supplied to the USB device 3 via the USB connector 12 and the state in which the electric power to the USB device 3 is cut off. When the computer device 1 cuts off supply of electric power to the USB device 3 via the USB connector 12, the USB device 3 ends operation if the USB device 3 operates only by electric power supplied via the USB connector 12. In this case, access from the computer device 1 to the USB device 3 which operates only by electric power supplied via the USB connector is cut off. On the other hand, a USB device which is supplied electric power from other power source devices and operates regardless of the presence of electric power supplied by the USB connector 12 from the computer device 1 continues operation even when the computer device 1 cuts off supply of electric power via the USB connector 12. In this case, access from the computer device 1 to the USB device which can operate using electric power supplied only from other power source devices is not cut off.

Also, in the computer device 1 of this exemplary embodiment, there is a second effect that access by not intended operation or malicious operation to the USB device 3 which is connected with the computer device 1 and which operates only by electric power supplied by USB from the computer device 1 can be shut out.

Further, in this exemplary embodiment, there is a third effect that power consumption can be reduced.

The reason is because, according to the direction which the operator inputs via the input unit 2, the control unit 11 transmits to the power supply switching device 10 the direction to switch to the supplying state and the direction to be the cutoff state. According to the direction received from the control unit 11, the power supply switching device 10 switches to be in the state to supply electric power to the USB device 3 via the USB connector 12 or in the state to cut off electric power for the USB device 3.

When it the operator need not access the USB device 3, the operator can shut out access from the computer device 1 to the USB device 3 by making the power supply switching device 10 in the cutoff state. Also, when the operator need not access the USB device 3, the operator can make the USB device 3 not spend electric power by making the power supply switching device 10 in the cutoff state.

Next, a detailed explanation will be given for a second exemplary embodiment with reference to the drawings.

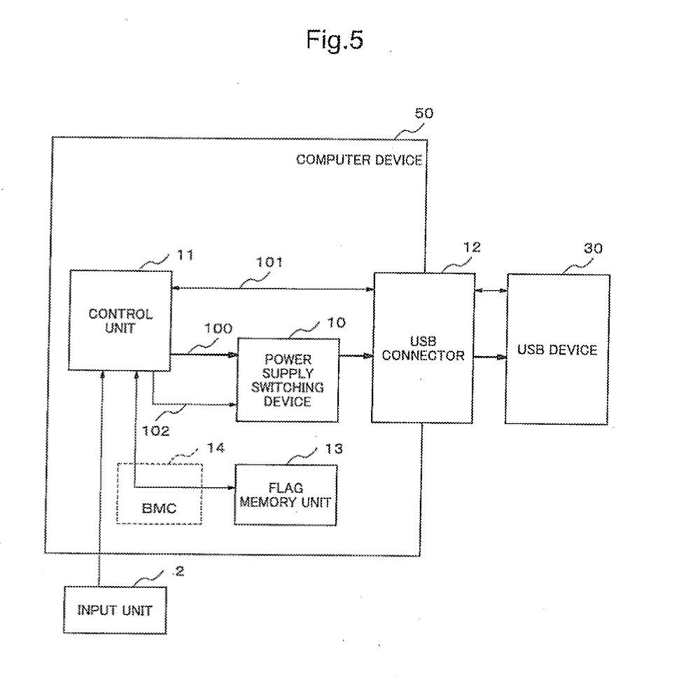

FIG. 5 is a block diagram illustrating an example of the structure of a computer system according to this exemplary embodiment.

Compared with the structure of the first exemplary embodiment shown in FIG. 1, in the structure of this exemplary embodiment, the computer device 1 and the USB device 3 are replaced by a computer device 50 and a USB device 30 respectively. And, the computer device 50 includes a flag memory unit 13 connected with the control unit 11 and the computer device 50 may include BMC 14 (Baseboard Management Controller). In the following description, the difference between this exemplary embodiment and the first exemplary embodiment will be explained mainly.

The flag memory unit 13 stores a flag which is information representing whether a USB device 30, which is, for example, a USB memory, is connected with the computer device 50.

As mentioned above, among USB memories, which are connected with USB connectors contained in a housing of a computer device such as a server, there exists one which stores software, for example, for maintenance.

The flag memory unit 13 stores in advance the flag representing whether a USB device 30 such as a USB memory, which stores, for example, software for maintenance, is connected via USB with the computer device 50. For example, the operator who connected the USB device 30 with the computer device 50 may store the flag in the flag memory unit 13 in advance. The flag memory unit 13 can be realized by a non-volatile memory.

The flag of this exemplary embodiment takes a value among two or more values. In an example in this exemplary embodiment, the flag takes a value among values representing “valid” and “invalid”. In the following description, “flag is valid” represents that the USB device 30 is connected with the computer device 50. And, “flag is not valid.” represents that the USB device 30 is not connected with the computer device 50. However, a correspondence between the value, which is “valid” or “invalid”, of the flag and the state whether the USB device 30 is connected with the computer device 50 or not may be reverse to the correspondence described above.

The flag memory unit 13 may be connected with the control unit 11 via the BMC 14. The BMC 14 is a management controller which operates based on IPM (Intelligent Platform Management Interface) specifications which are a standard. In this case, the control unit 11 and the BMC 14 may be connected via a bus, for example. And, the BMC 14 and the flag memory unit 13 can be connected, for example, via SPI (Serial Peripheral Interface). The SPI is a bus which is generally used inside a computer.

In case the flag read from the flag memory unit 13 is valid, the control unit 11 of this exemplary embodiment receives from the input unit 2 the supplying direction or the cutoff direction, and in case the flag read from the flag memory unit 13 is not valid the control unit 11 does not receive from the input unit 2 either the supplying direction or the cutoff direction. In case the control unit 11 does not receive either the supplying direction or the cutoff direction from the input unit 2, the control unit 11 of this exemplary embodiment does not give the direction to the power supply switching device 10. In other respects, the control unit 11 of this exemplary embodiment and the control unit 11 of the first exemplary embodiment are the same.

According to this exemplary embodiment, in the initial state, the power supply switching device 10 is in the cutoff state. The initial state includes a state immediately after the power source of the computer device 50 is turned on and a state immediately after the computer device 50 is restarted.

Each of the other components of this exemplary embodiment is the same as the component to which the identical number is assigned and which is included in the first exemplary embodiment. Therefore, their description will be omitted.

Next, a detailed explanation will be given for the operation of this exemplary embodiment with reference to the drawings.

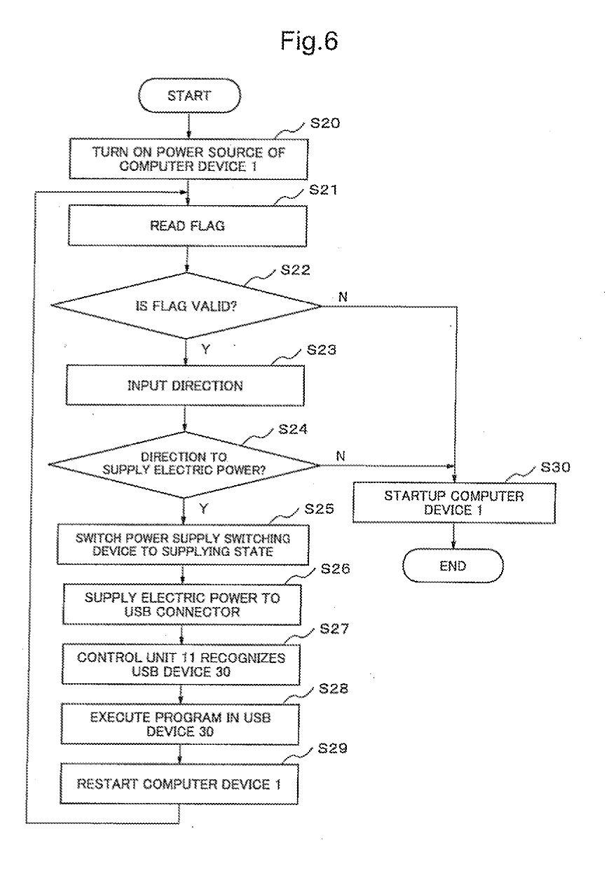

FIG. 6 is a flow chart illustrating the operation of this exemplary embodiment. The operation shown in FIG. 6 is an example of the operation at the time of startup of the computer device 50.

First, by an operation which is done by an operator, the power source of the computer device 50 is turned on (Step S20). According to this exemplary embodiment, in the initial state immediately after the power source of the computer device 50 is turned on, the control unit 11 sets the power supply switching device 10 in the cutoff state. As mentioned above, in case the power supply switching device 10 is in the cutoff state when the GPIO 102, for example, is Disable, the control units 11 may set the GPIO 102 to Disable in the initial state. When the power source is turned on, the computer device 50 executes POST (Power On Self Test) processing. The POST processing is a processing which a device such as a computer or a peripheral device, which operates by starting up an operating system, performs before starting up the operating system.

Next, as part of the POST processing, the control unit 11 reads the flag from the flag memory unit 13 (Step S21). In case the BMC 14 exists, the control unit 11 reads the flag via the BMC 14.

In case the flag which the control unit 11 read is not valid (Step S22, N), if other part of the POST processing is left unexecuted, the computer device 50 executes it, and after finishing the POST processing, the computer device 50 starts up according to the normal processing such as loading an operating system stored in a hard disk device which is not shown (Step S30).

In case the flag which the control unit 11 read is valid (Step S22, Y), the control unit 11 receives the supplying direction or the cutoff direction from the input unit 2 in the same way as Step S11 in the operation of the first exemplary embodiment (Step S23). For example, the control unit 11 displays a message prompting an input of a direction to the operator on a POST screen displayed on a display device which is not shown, and the input unit 2 may input a direction from the operator. The POST screen is a screen which the computer device 50 displays on the display device which is not shown during execution of the POST processing.

Further, although the computer system of this exemplary embodiment performs the processing of Step S30 in case the flag is not valid, and performs the processing of Step S23 in case the flag is valid, the correspondence between the flag and the processing may be the reverse.

In case the direction which the input unit 2 inputted is the supplying direction (Step S24, Y), the control unit 11 transmits the direction to switch to the supplying state to the power supply switching device 10 and switches the power supply switching device 10 to the supplying state (Step S25). For example, the power supply switching device 10 is supposed to be in the supplying state when the GPIO 102 is Enable, the control unit 11 may switch the power supply switching device 10 to the supplying state by setting the GPIO 102 to Enable.

In case the direction which the input unit 2 inputted is not the supplying direction (direction to switch to the supplying state) (Step S24, N), the computer device 50 starts up according to the normal processing (Step S30).

When the power supply switching device 10 switches to the supplying state, electric power is supplied to the USB connector 12 (Step S26). By electric power being supplied to the USB connector 12, electric power is supplied to the USB device 30 connected with the USB connector 12. If the USB device 30 operates using electric power supplied only from USB, the USB device 30 begins to operate at the time when electric power is supplied to the USB connector 12.

When the USB device 30 begins to operate, the control unit 11 recognizes the USB device 30 (Step S27). If an operating system is stored in the USB device 30, the control unit 11 may load the operating system from the USB device 30 after Step S27.

As mentioned above, if, for example, a program for maintenance is stored in the USB device 30, the operator of the computer device 50 may perform maintenance of the computer device 50 by executing the program stored in the USB device 30 (Step S28).

When the maintenance ends and accessing the USB device 30 becomes unnecessary, the operator restarts the computer device 50 (Step S29). The restarted computer device 50 becomes in the same state as a state immediately after the power source is turned on, and the processing proceeds to Step S21.

In the exemplary embodiment described above, in addition to the same effect as the effect of the first exemplary embodiment, there is an effect that mistaking a USB memory for a hard disk device at the time of startup is prevented, and access to the USB device 30 which is not necessary to be accessed at the time of ordinary startup is shut out.

The reason is because the control unit 11 switches the power supply switching device 10 to the supplying state as a part of the POST processing based on the direction via the input unit 2.

As mentioned above, among computer devices such as a server, there exists a computer device which stores software, for example, for maintenance, in a USB device such as a USB memory connected with an internal USB connector contained in a housing of the computer device. In case other USB device 30 such as a hard disk device is further connected with the computer device via USB, and in particular, when the USB memory has large capacity, it is difficult for the computer device 50 to distinguish the USB memory from the hard disk device.

If the USB device 30 such as the USB memory mentioned above is connected with the computer device 50, and when electric power is supplied to the USB device 30, it is possible to access the USB device 30. Therefore, there is a possibility, by an incorrect operation or a malicious operation, that a file in the USB device 30, such as the USB memory mentioned above storing software, for example, for maintenance, may be rewritten or erased. Also, if electric power is supplied to the USB device 30 at the time of startup of the computer device 50, the computer device 50 may mistake the USB memory for the hard disk device. For example, there is a possibility that, if the operating system should be loaded normally from other hard disk device, the computer device 50 may try to load it from the USB memory by mistake.

However, in case the control unit 11 performs switching to the supplying state while the POST processing, the presence or absence of electric power supply to the USB connector 12 is set while the POST processing and will not change after that. For example, when the absence of electric power supply to the USB connector 12 is set, at least until the next POST processing of the computer device 50, electric power is not supplied to the USB device 30 such as a USB memory. In this case, the USB device 30 such as a USB memory, which operates only by electric power supplied from a USB connector, does not operate. On the other hand, even if electric power is not supplied from a USB connector, the USB device 30 such as a hard disk device, to which electric power is supplied from other power source device, operates. Accordingly, in this case, the computer device 50 does not confuse a USB memory with a hard disk device. And, the computer device 50 cannot access a USB memory which is not operating.

The control unit 11 of each of the exemplary embodiment of the present invention can be realized by hardware such as a circuit, by a computer controlled by a program or by their combination. For example, the control unit 11 can be realized by a combination of all of or a part of: a CPU (Central Processing Unit) and a program which controls the CPU, a USB controller, and a circuit which generally controls I/O (Input/Output).

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A power supply switching device comprising:
a first connector which connects with a USB (Universal Serial Bus) power bus which supplies electric power;
a second connector which connects with a USB connector; and
a switching unit which switches between a supplying state in which electric power is supplied from the USB power bus to the USB connector and a cutoff state in which electric power is not supplied from the USB power bus to the USB connector.

2. The power supply switching device according to claim 1, wherein
the second connector connects with a power source pin of the USB connector, and
the switching unit further comprises
a power switch which is connected with the first connector and the second connector, connects between the power bus and the power source pin in the supplying state, and makes the power bus and the power source pin be disconnected in the cutoff state.

3. A computer device comprising:
the power supply switching device according to claim 1 wherein the switching unit switches to the supplying state when receiving a supplying state switching direction which is a direction to switch to the supplying state;
an input unit which inputs a direction; and
a control unit which is connected to the power supply switching device, and outputs the supplying state switching direction to the power supply switching device in case the inputted direction is a supplying direction which is a direction to supply electric power to the USB connector.

4. The computer device according to claim 3 further comprising:
a flag memory unit which stores a flag which takes a value among two or more values, wherein
the control unit reads the value of the flag from the flag memory unit; lets the input unit input the direction in case the read value is a predetermined value, and does not let the input unit input the direction in case the read value is not the predetermined value.

5. The computer device according to claim 3, wherein
the power supply switching device is in the cutoff state in an initial state; and
the control unit outputs the supplying state switching direction as part of POST (Power On Self Test) processing of the computer device.

6. A computer system comprising:
the computer device according to claim 3; and
a USB device which is connected to the computer device via the USB connector, and is supplied with electric power only via the USB connector.

7. A power supply switching device control method comprising:
inputting a direction; and
outputting a supplying state switching direction, which is a direction to switch to the supplying state, to the power supply switching device according to claim 1 wherein the switching unit switches to the supplying state when receiving the supplying state switching direction, in case the inputted direction is a supplying direction which is a direction to supply electric power to the USB connector.

8. The power supply switching device control method according to claim 7 further comprising:
storing a flag which take a value among two or more values in a flag memory unit;
reading the value of the flag from the flag memory unit;
letting the direction being inputted in case the read value is a predetermined value; and
not letting the direction being inputted in case the read value is not the predetermined value.

9. A non-transitory computer readable medium embodying a power supply control program which makes a computer connected with the power supply switching device according to claim 1 operate
as an input unit which inputs a direction, and
as a control unit which is connected with the power supply switching device, and outputs a supplying state switching direction, which is a direction to switch to the supplying state, to the power supply switching device in case the direction is a supplying direction which is a direction to supply electric power to the USB connector, wherein
the power supply switching device switches to the supplying state when receiving the supplying state switching direction.

10. The non-transitory computer readable medium according to claim 9 embodying a power supply control program which makes the computer operate
as a flag memory unit which stores a flag which take a value among two or more values, and
as the control unit which reads the value of the flag from the flag memory unit, lets the input unit input the direction in case the read value is a predetermined value; and does not let the input unit input the direction in case the value is not the predetermined value.

11. A power supply switching device comprising:
a first connecting means for connecting with a USB (Universal Serial Bus) power bus which supplies electric power;
a second connecting means for connecting with a USB connector; and
a switching means for switching between a supplying state in which electric power is supplied from the USB power bus to the USB connector and a cutoff state in which electric power is not supplied from the USB power bus to the USB connector.
